(19) United States
(12) Patent Application Publication
(10) Pub. No.: US 2020/0109739 A1
(43) Pub. Date: Apr. 9, 2020

(54) Component System Of A Vehicle

(71) Applicant: Webasto SE, Stockdorf (DE)

(72) Inventors: Anilash Panikulangara, Stockdorf (DE); Dennis Felker, Stockdorf (DE)

(21) Appl. No.: 16/151,772

(22) Filed: Oct. 4, 2018

(51) Int. Cl. F16C 1/10; F16C 1/12; B60J 7/20

(52) U.S. Cl. CPC F16C 1/101; F16C 2326/01; B60J 7/203; F16C 1/12

(57) ABSTRACT

The disclosure relates to a component system of a vehicle comprising a vehicle element which is displaceable in relation to a base element and connected to a drive cable system which can be driven by a drive and comprises a first cable unit and a second cable unit which is connected to the first cable unit via a connecting unit. The connecting unit comprises a coupling box in which a spring element acting on a cable of the first cable unit is disposed.

### CROSS-REFERENCE TO RELATED APPLICATION

Not applicable.

### STATEMENT CONCERNING FEDERALLY SPONSORED RESEARCH OR DEVELOPMENT

Not applicable.

### FIELD

The disclosure relates to a component system of a vehicle comprising a vehicle element which can be displaced in relation to a base element by means of a drive cable system.

### BACKGROUND

From practical experience, it is known for a motor vehicle to have a vehicle element which is displaced between two positions by means of a cable which is configured as what is known as a Bowden cable. The vehicle element is an element of a convertible top or a flap of a convertible vehicle, for example, which can be displaced by means of the drive cable system between a closed position, in which it closes a vehicle opening, and an open position, in which the vehicle opening is open. A drive, which may comprise an electric motor or a hydraulic element, for example, is provided for actuation of the drive cable system connected to the vehicle element. The distance between the drive and the displaceable vehicle element is often very large. Hence, if damage occurs, replacement of the drive cable system may be very complicated. Furthermore, peak loads that may damage the component system can act on the vehicle element when the drive is actuated.

### SUMMARY

An object of the disclosure is to provide a component system of a vehicle in which a vehicle element can be driven via a drive cable system in such a manner that the risk of peak loads introduced by the drive is counteracted on the one hand and installation and maintenance of the drive cable system is convenient on the other hand.

To attain said object, a component system of a vehicle is proposed that comprises a vehicle element which is displaceable in relation to a base element and connected to a drive cable system which can be driven by a drive and comprises a first cable unit and a second cable unit which is connected to the first cable unit via a connecting unit, wherein the connecting unit comprises a coupling box in which a spring element is disposed against which a cable of the first cable unit rests, i.e. which acts on the cable of the first cable unit. The component system according to the disclosure thus comprises at least two cable units which are connected to each other via a coupling box. In the coupling box, which constitutes a quick connect element for the two cable units, a compensation element in the form of the spring element is disposed, said compensation element acting on the two cable units in such a manner that peak loads can be absorbed on the one hand and tolerances can be compensated in terms of the length of the two cable units on the other hand, which, in turn, facilitates installation. The coupling box having the spring element thus constitutes a compensator which increases variability of the drive cable system. Moreover, the multi-part design of the drive cable system in the form of the two cable units facilitates installation and maintenance because the coupling box can be installed according to requirements on the one hand and only one of the cable units may have to be replaced in case of damage on the other hand. Moreover, the spring element disposed in the coupling box can absorb misuse loads, thus allowing the risk of peak loads acting on the vehicle element to be actuated by means of the drive cable system to be minimized.

Thus, the drive cable system utilizes two separate cable units. The coupling box is a quick connect box that can be located at any point along the length of the drive cable system routing. This enables high flexibility in the manufacturing process of the respective vehicle, as each cable unit can be preassembled to different sub-assemblies which can then be brought together and connected at the vehicle. The ability to attach the quick connect box at any location enables to solve issues of reachability, accessibility and ergonomic issues.

According to a specific embodiment of the component system, a cable of the second cable unit rests against a first end wall of the coupling box via a coupling element, the cable running through a recess of the first end wall. Thus, the coupling element of the cable of the second cable unit is in contact with the first end wall of the coupling box from inside.

In order for the coupling element of the second cable unit to have a defined position within the coupling box, the latter preferably has a receiving portion for said coupling element.

According to another specific embodiment, the coupling box has another recess at its second end wall, said recess being traversed by the cable of the first cable unit. So the cable of the first cable unit, too, is routed into the interior of the coupling box.

According to another aspect, the spring element of the proposed component system is a coil spring which is traversed by the cable of the first cable unit in the axial direction. So the cable traverses in particular the second end wall of the coupling box and the coil spring such that a coupling element of the cable of the first cable unit engages at a side of the coil spring whose other end rests against the inner side of the second end wall.

In order for the coupling box to always be in a defined position when the drive cable system is actuated, it is mounted to slide on a support and slidable in a specific embodiment.

The coupling box of the proposed component system can have a lid which covers an interior of the coupling box. By opening the lid, the two ends of the cables of the two cable units and the spring element become accessible, which ensures easy installation or removal of the cable units.

Each cable unit of the component system according to the disclosure is configured in particular as what is known as a Bowden cable, which has a cable conduit in which a respective cable is routed. By fixing the cable conduits to corresponding components of the vehicle, the cable units and thus the drive cable system can be routed from the drive to the vehicle element to be driven according to the space conditions at hand. The cable conduits can remain stationary in relation to the components to which they are fixed when the drive cable system is actuated. Only the cables and the coupling box will move.

Thus, the conduits of the cables may remain stationary during the use of the drive cable system, as the spring compensation function is based on the movement of the cables and not of the conduits. This allows the cable units to be routed effectively in very tight packaging conditions around outer vehicle surfaces (class A surfaces) where the conduits need to remain rigidly fixed to avoid concerns of interferences or damages to surrounding components.

At their ends, the cable conduits of the cable units preferably each have a bearing element via which they can be fixed to a support. The support is formed by a main bearing of a top linkage of a convertible vehicle, for example.

At least one of the bearing elements of the cable units can serve as a stop for the coupling box, thus limiting the path of travel of the coupling box. This can prevent faulty actuation of the vehicle element to be displaced.

In a specific embodiment of the component system according to the disclosure, the vehicle element is a linkage outlet flap of a convertible vehicle. The drive cable system exerts a displacing force on the linkage outlet flap in particular in the pulling direction. To ensure that the linkage outlet flap returns into a closed position or an open position when the drive cable system is released, the linkage outlet flap can be pre-loaded by means of a spring system which automatically displaces the linkage outlet flap into the closed position, in particular, or into the open position when the drive cable system is released.

Other advantages and advantageous embodiments of the subject-matter of the disclosure are apparent from the description, the drawings and the claims.

### BRIEF DESCRIPTION OF THE DRAWINGS

An exemplary embodiment of a component system according to the disclosure is illustrated in the drawing in a schematically simplified manner and will be explained in more detail in the following description.

FIG. 1 shows a perspective rear view of a convertible vehicle having two linkage outlet flaps.

FIG. 2 shows a perspective view of a top linkage system disposed to the left of a longitudinal center plane of the vehicle with a vehicle-attached main bearing and a mechanism for displacing one of the two linkage outlet flaps.

FIG. 3 shows a side view of the top linkage system of FIG. 2.

FIG. 4 shows a perspective view of a first cable unit of a drive cable system for displacing the linkage outlet flap and a coupling box.

FIG. 5 shows a side view of the cable unit in the stretched position and the coupling box.

FIG. 6 shows a longitudinal section through the cable unit and the coupling box along line VI-VI in FIG. 5.

FIG. 7 shows a perspective view of a second cable unit of the drive cable system.

FIG. 8 shows a side view of the second cable unit in the stretched position.

FIG. 9 shows a section through the second cable unit along line IX-IX in FIG. 8.

FIG. 10 shows a cross-section through the second cable unit along line X-X in FIG. 8.

FIG. 11 shows an enlarged illustration of area XI in FIG. 6.

FIG. 12 shows a front view of the coupling box.

FIG. 13 shows a second front view of the coupling box.

FIG. 14 shows a second longitudinal section through the coupling box along line XIV-XIV in FIG. 11.

### DETAILED DESCRIPTION

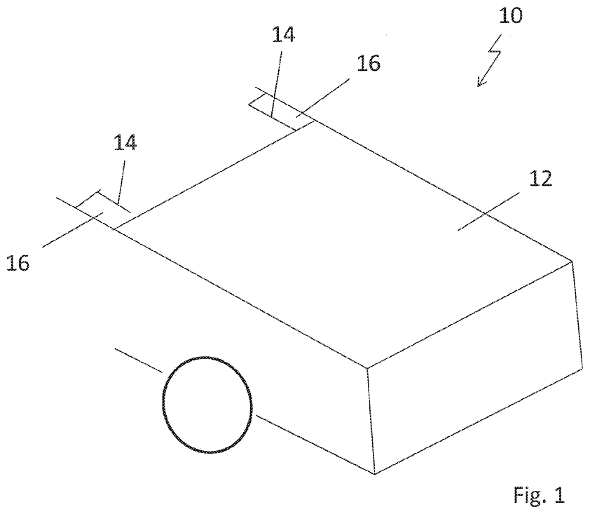

FIG. 1 shows a motor vehicle 10 which is a convertible vehicle and which has a convertible top (not illustrated) which can be displaced between a closed position, in which it covers a vehicle interior, and a storage position, in which the vehicle interior is open at the top. When in the storage position, the top is accommodated in a top storage space which is formed in a rear portion of the motor vehicle 10 and which can be closed by means of a top box lid 12.

In order to be able to guide a top linkage from the top storage space 12 upward and over the vehicle interior when the top is in the closed position, the motor vehicle 10 has a linkage outlet opening 14 on each side in the area of its beltline, said linkage outlet opening 14 being closed by means of a linkage outlet flap 16 when the top is stored in the top storage space, i.e. when it is in its storage position.

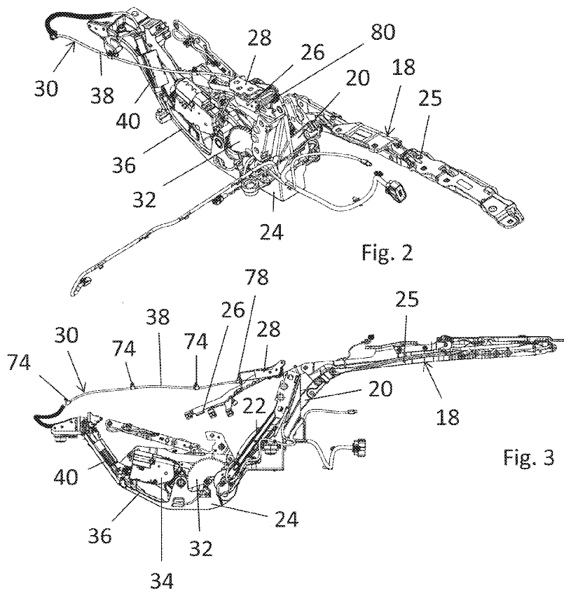

The top linkage of the convertible top has a linkage system 18 on either side of a longitudinal center plane of the vehicle, which is illustrated in FIGS. 2 and 3 and on which rigid roof shells can be mounted in the case at hand. The linkage systems 18, which are mirror symmetrical to each other, each comprise two main links 20 and 22, which are pivotably mounted on a respective vehicle-attached main bearing 24 disposed in the area of the top storage space. At their ends facing away from the main bearing 24, the two main links 20 and 22 are connected to a roof link 25 and, when the convertible top is the closed position, are guided out of the top storage space upward through the respective linkage outlet opening 14 toward the respective roof link 25.

The linkage outlet flaps 16, by means of which the linkage outlet openings 14 can be closed when the top is in the storage position, are each mounted on a support plate 26 which is pivotably mounted on a vehicle-attached flap bearing 28, which constitutes a base element. In FIGS. 2 and 3, the support plate 26 is located in the position associated with the open position of the linkage outlet flap 16.

For being driven, the support plate 26 is connected to a drive cable system 30 which can be driven by a drive wheel 32 which is rotatably disposed on the main bearing 24 and which can be driven by means of a drive motor 34.

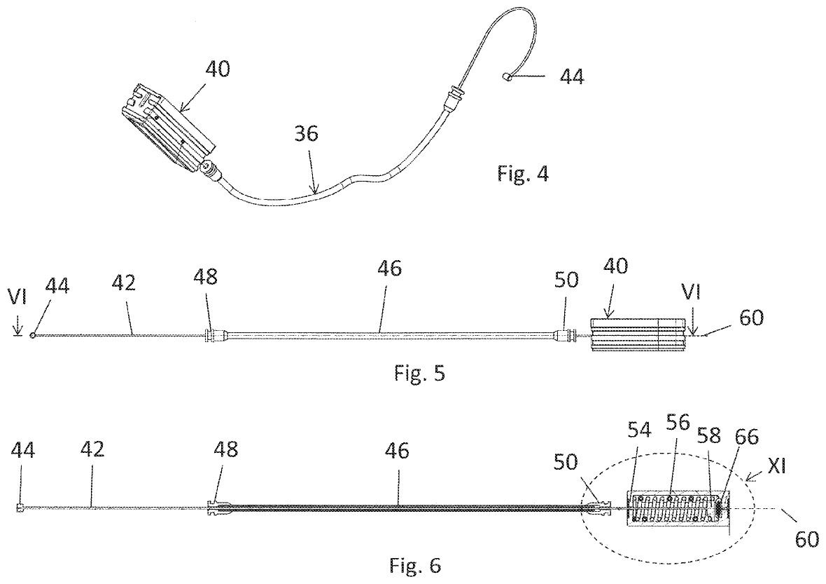

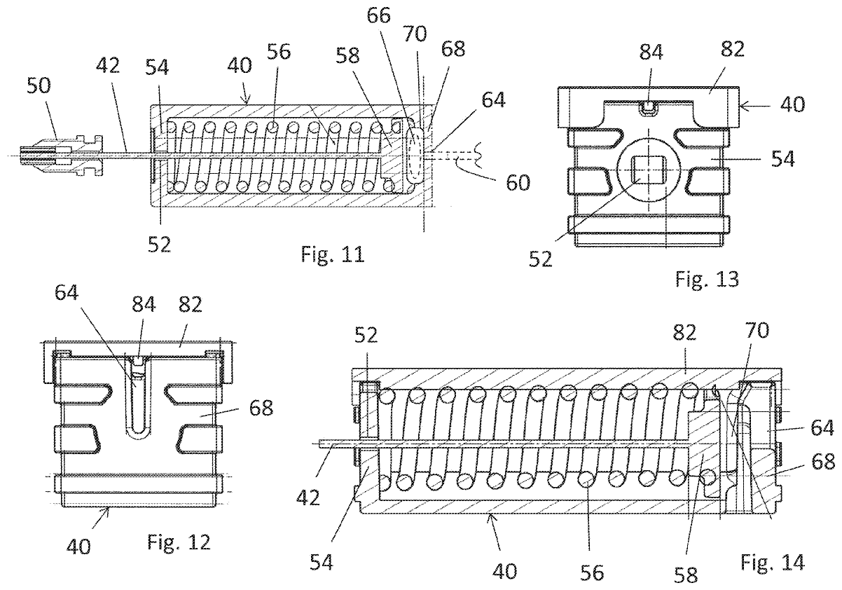

The drive cable system 30, which is illustrated in detail in FIGS. 4 to 14, comprises a first cable unit 36 and a second cable unit 38, which is connected to the first cable unit 36 via a coupling box 40, which constitutes a connecting unit.

The first cable unit 36, which is configured as a Bowden cable and is illustrated in FIGS. 4 to 6 in particular, comprises a cable 42 made of a steel wire strand which has a nipple 44 for connecting the steel wire strand to the drive wheel 32 at one end and is routed into the coupling box 40 with its other end. The cable 42 is routed in a cable conduit 46 which is fixed to the main bearing 24, which constitutes a base element. For this purpose, the cable conduit 46 comprises bearing elements 48 and 50 at its ends, the bearing elements 48 and 50 being fixed to corresponding counterparts of the main bearing 24 when in the installed state.

The cable 42 is routed into an interior of the coupling box 40 via a hole-shaped recess 52 which is formed on an end wall 54 of the coupling box 40. In the interior of the coupling box 40, the cable 42 traverses a coil spring 56, one end of which rests against the end wall 54. A plate-shaped coupling element 58 attached to the end of the cable 42 engages the other end of the coil spring 56. Thus, the cable 42 rests against the spring element formed by the coil spring 56, i.e. the coil spring 56 acts on the cable 42.

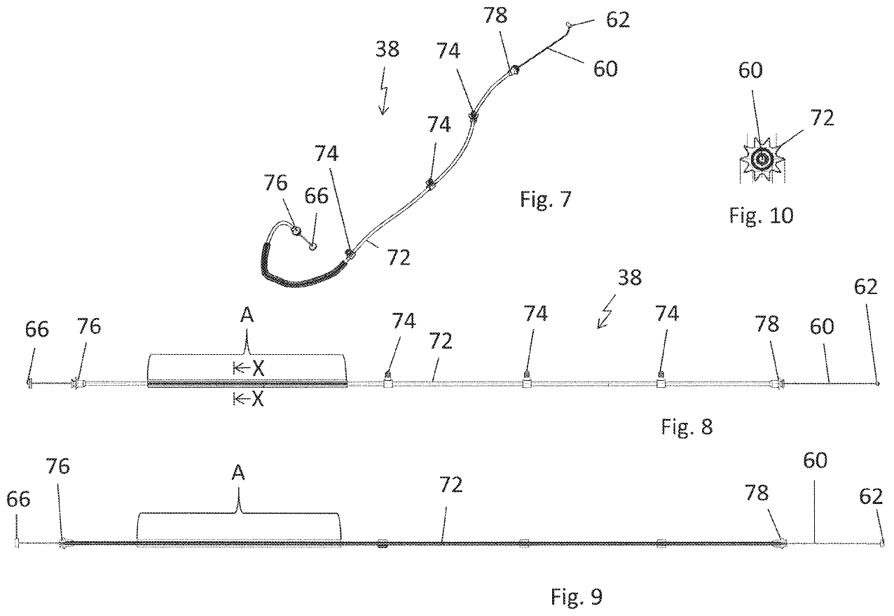

The second cable unit 38, which is illustrated on its own in FIGS. 7 to 10, is also configured as a Bowden cable and comprises a cable 60 which is formed by a steel wire strand and which has a nipple 62 for connecting the steel wire strand to the support plate 26 at one end and which is routed into the interior of the coupling box 40 at its other end via a slot 64, where it is in contact with a second end wall 68 of the coupling box 40 from inside via a plate-shaped coupling element 66. The coupling element 66 is disposed in a receiving portion 70.

The cable 60 is routed in a cable conduit 72 which has a star-shaped cross-section in a section A and which is provided with three fixing elements 74 for being connected to the vehicle body and with two end-side bearing elements 76 and 78, the bearing element 76 being attached to the vehicle-attached main bearing 24 and the bearing element 78 being attached to the flap bearing 28.

The coupling box 40 has a lid 82 by means of which the interior of the coupling box 40 is closed. The removable lid 82 is latched to the coupling box 40 via pins 84 or a rib.

The support plate 26 to which the respective linkage outlet flap 16 is attached is pre-loaded into an open position by means of a restoring spring 80, causing the linkage outlet flap 16 to automatically move into its open position when drive cable system 30 is released. If a pulling force against the spring force of the restoring spring 80 is exerted on the support plate 26, it is pivoted together with the linkage outlet flap 16 into the closed position in which the linkage outlet opening is closed and in which the convertible top is located in its storage position and the vehicle interior is open at the top.

When the drive cable system 30 is actuated, the pulling force introduced into the cable 42 is attenuated by the coil spring 56 and transmitted via the coupling box 40 to the cable 64 and thus onto the support plate 26 of the linkage outlet flap. The coupling box 40 is caused to slide on the main bearing 24, which constitutes a support.

I/We claim:

1. A component system of a vehicle, comprising a vehicle element which is displaceable in relation to a base element and connected to a drive cable system which can be driven by a drive and comprises a first cable unit and a second cable unit which is connected to the first cable unit via a connecting unit, wherein the connecting unit comprises a coupling box in which a spring element acting on a cable of the first cable unit is disposed.

2. The component system according to claim 1, wherein a cable of the second cable unit rests against a first end wall of the coupling box via a coupling element and runs through a recess of the first end wall.

3. The component system according to claim 2, wherein the coupling box has a receiving portion for the coupling element.

4. The component system according to claim 1, wherein the cable of the first cable unit runs through a recess of a second end wall of the coupling box.

5. The component system according to claim 1, wherein the spring element is a coil spring which is traversed by the cable of the first cable unit in the axial direction.

6. The component system according to claim 1, wherein the coupling box is mounted to slide on a support.

7. The component system according to claim 1, wherein the coupling box has a lid.

8. The component system according to claim 1, wherein each cable unit has a cable conduit in which a respective cable is routed.

9. The component system according to claim 8, wherein each cable conduit has a bearing element at its end via which they can be fixed to a support.

10. The component system according to claim 9, wherein the bearing element of the cable conduit of the first cable unit that faces toward the coupling box forms a stop for the coupling box.

11. The component system according to claim 1, wherein the vehicle element is a linkage outlet flap of a convertible vehicle.

12. The component system according to claim 11, wherein the linkage outlet flap is pre-loaded by means of a spring system which automatically displaces the linkage outlet flap when the drive cable system is released.
